(19) United States
(12) Patent Application Publication
(10) Pub. No.: US 2008/0084493 A1
(43) Pub. Date: Apr. 10, 2008

(54) Camera, camera unit and camera system

(75) Inventor: Masahito Ochi, Chiba-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/907,085

(22) Filed: Oct. 9, 2007

(30) Foreign Application Priority Data
Oct. 10, 2006 (JP) 2006-276161

(51) Int. Cl. H04N 5/225

(52) U.S. Cl. 348/341

(57) ABSTRACT

A camera includes a first image pickup section photographing a recording-purpose image, a viewfinder optical system, a second image pickup section, and a displaying section. The viewfinder optical system has an eyepiece section capable of observing an optical image of a subject with a light flux from a photographing optical path of the first image pickup section. The second image pickup section photographs a view confirming image from an optical path different from that of the first image pickup section. The displaying section provides the view confirming image to an eyepiece section.

### CROSS-REFERENCE TO RELATED APPLICATION

This application is based upon and claims the benefit of priority from Japanese Patent Application No. 2006-276161, filed Oct. 10, 2006, the entire content of which is incorporated herein by reference.

### BACKGROUND

1. Field

The present invention relates to a camera with a viewfinder suitable for telescopic photographing and the like, and to a camera unit and camera system associated with the same.

2. Description of the Related Art

Conventionally, a digital camera can determine a photographing composition by displaying an image currently being photographed on a display device, such as an LCD monitors. Especially in a video camera, there is also known a camera wherein an auxiliary image pickup section that photographs a wide angle image for viewfinder display is provided independently of a recording-purpose image pickup section. In addition, Japanese Unexamined Patent Application Publication No. H05-145818 is listed as an example of the above-described camera.

Incidentally, a conventional single lens reflex camera includes a TTL (Through The Lens) optical viewfinder that observes an image of a subject with a reflected light from a movable mirror disposed on a photographing optical path. In such an optical viewfinder, the state of a subject passing through an optical shooting system can be confirmed as it is and the range of field of view by means of the optical viewfinder substantially coincides with a field angle of the optical shooting system. For this reason, especially when the field angle of the optical shooting system is narrow as in telescopic photographing, there is a room for improvement in that a user is likely to lose sight of a moving subject and miss photo opportunity.

### SUMMARY

The present invention has been made in view of the above-described problems of the prior art. It is an object of the present invention to provide means, which can confirm the state of field in a wider range than the range of the optical shooting system without detaching eyes from an optical viewfinder.

A camera according to a first invention includes a first image pickup section that photographs a recording-purpose image, a viewfinder optical system, a second image pickup section, and a displaying section. The viewfinder optical system has an eyepiece section that can observe an optical image of a subject with a light flux from a photographing optical path of the first image pickup section. The second image pickup section photographs a view confirming image from an optical path different from that of the first image pickup section. The displaying section provides the view confirming image to the eyepiece section.

According to a second invention, in the first invention, the second image pickup section is disposed in an overhang part housing an optical element of the viewfinder optical system, the overhang part formed in an upper part of a camera body.

According to a third invention, in the first invention, the camera further includes a movable member that can move between a first position where the movable member is housed in the camera body and a second position where the movable member projects from the camera body. Then, the second image pickup section is attached to the movable member.

According to a fourth invention, in the third invention, an emitting section for irradiating the subject is contained in the movable member.

According to a fifth invention, in the first invention, the second image pickup section has a lens interchanging section that can interchangeably detach and attach lenses having respectively different focal lengths.

According to a sixth invention, in the first invention, the second image pickup section has a zoom lens capable of changing a focal length.

According to a seventh invention, in the first invention, the camera further includes an operation section and a controlling section. The operation section accepts from a user a displaying operation asking for display of the view confirming image. The controlling section causes the displaying section to display the view confirming image based on the displaying operation.

An eighth invention provides a camera unit which is externally attached to a camera body and which photographs a view confirming image from an optical path different from a photographing optical path of the camera body. The camera unit includes an image pickup section that photographs the view confirming image, a communication section that outputs the view confirming image to the camera body, a fixing section for connecting with the camera body, and a position adjusting section that adjusts parallax with an image pickup section of the camera body.

According to a ninth invention, in the eighth invention, the image pickup section has a lens interchanging section that can interchangeably detach and attach lenses having respectively different focal lengths.

According to a tenth invention, in the eighth invention, the image pickup section has a zoom lens capable of changing a focal length.

An eleventh invention provides a camera to which an external camera unit can be attached. The camera includes a fixing section for connecting the camera unit, an image pickup section that photographs a recording-purpose image, a viewfinder optical system having an eyepiece section that can observe an optical image of a subject with a light flux from a photographing optical path of the first image pickup section, a communication section that receives from the camera unit a view confirming image photographed through an optical path different from that of the image pickup section, and a displaying section that provides the view confirming image to the eyepiece section.

According to a twelfth invention, in the eleventh invention, the camera further includes an operation section and a controlling section. The operation section accepts from a user a displaying operation asking for display of the view confirming image. The controlling section causes the displaying section to display the view confirming image based on the displaying operation.

A thirteenth invention provides a camera system having a camera body and a camera unit that is externally attached to the camera body. The camera unit includes a second image pickup section that photographs a view confirming image from an optical path different from a photographing optical path of the camera body, a second communication section that outputs the view confirming image to the camera body, and a second fixing section for connecting with the camera body. Moreover, the camera body includes a first fixing section for connecting the camera unit, a first image pickup section that photographs a recording-purpose image, a viewfinder optical system having an eyepiece section that can observe an optical image of a subject with a light flux from a photographing optical path of the first image pickup section, a first communication section that receives the view confirming image from the camera unit, and a displaying section that provides the view confirming image to the eyepiece section.

### BRIEF DESCRIPTION OF THE DRAWINGS

FIG. 1 is an explanatory view of a photographing mechanism of an electronic camera in a first embodiment;

FIG. 2 is a front view of a camera body in the first embodiment;

FIG. 3 is a block diagram of the camera body in the first embodiment;

FIG. 4 is a flow chart showing the operation of the electronic camera regarding a wide preview display in the first embodiment;

FIG. 5 is a view showing a display state of an optical image of a subject in a viewfinder optical system;

FIG. 6 is a view showing an example of a view confirming image in the wide preview display;

FIG. 7 is a view showing the state of the camera body during the wide preview display;

FIG. 8 is an explanatory view of a photographing mechanism of an electronic camera in a second embodiment;

FIG. 9 is a perspective view showing a state where a movable member is in a second position;

FIG. 10 is an explanatory view of a photographing mechanism of an electronic camera system in a third embodiment; and

FIG. 11 is a block diagram of the electronic camera system in the third embodiment.

### DETAILED DESCRIPTION OF THE EMBODIMENTS

### Description of First Embodiment

Hereinafter, the structure of a single lens reflex electronic camera of a first embodiment will be described with reference to the accompanying drawings.

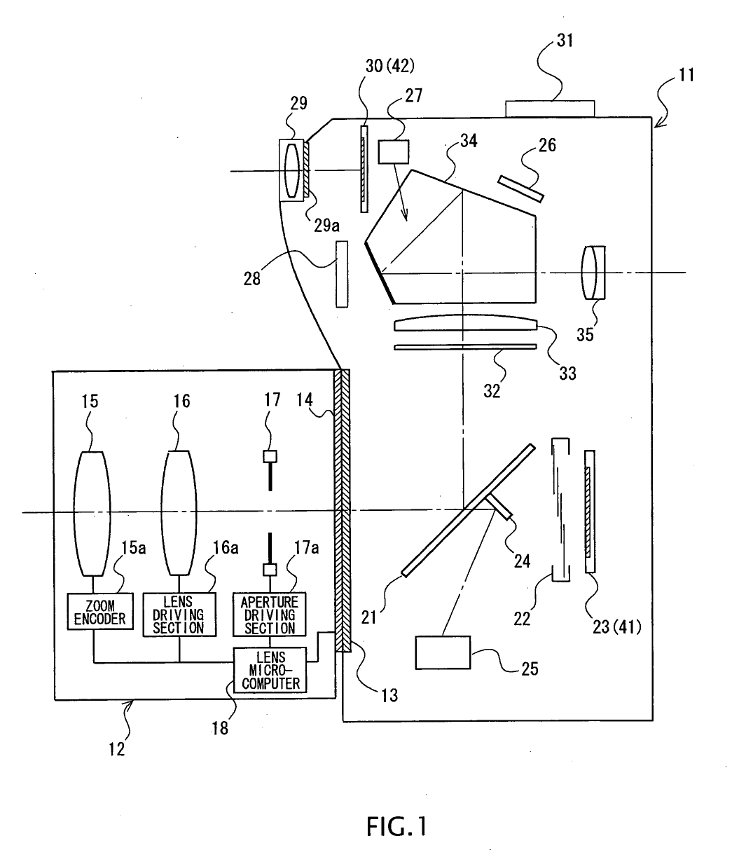

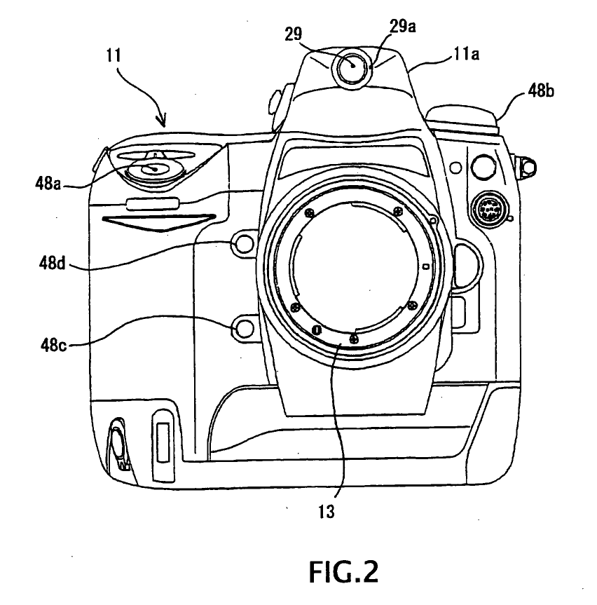

FIG. 1 is a view illustrating a photographing mechanism of the electronic camera in the first embodiment. Moreover, FIG. 2 is a front view of a camera body in the first embodiment. The electronic camera of the first embodiment includes a camera body 11, and a lens unit 12 that houses an optical shooting system.

A pair of mounts 13, 14 serving as male and female mounts is provided in the camera body 11 and the lens unit 12, respectively. The lens side mount 14 is coupled with the camera side mount 13 by means of a bayonet mechanism or the like, whereby the lens unit 12 is interchangeably attached to the camera body 11. Moreover, electric contacts (not shown) are provided in the above-described mounts 13, 14, respectively. When the camera body 11 is connected to the lens unit 12, contact between the electric contacts results in the establishment of electrical connection between the both.

First, the structure of the lens unit 12 is described. The lens unit 12 includes a zoom lens 15, a zoom encoder 15a, a focus lens 16, a lens driving section 16a, an aperture 17, an aperture driving section 17a, and a lens microcomputer 18. In addition, the zoom encoder 15a, the lens driving section 16a, and the aperture driving section 17a are connected to the lens microcomputer 18, respectively.

The zoom lens 15 is a lens for adjusting a focal length, and is movable forward and backward in the optical axis direction in response to the operation of a zoom ring (not shown). Moreover, the zoom encoder 15a for detecting a position in the optical axis direction of the lens is attached to the zoom lens 15.

The focus lens 16 is a lens for adjusting a focus position and is movable forward and backward in the optical axis direction. The lens driving section 16a drives the focus lens 16 by a motor (not shown) and outputs a position in the optical axis direction of the focus lens 16 to the lens microcomputer 18.

The aperture 17 adjusts the amount of light incident upon the camera body 11 by opening and closing aperture blades. The aperture driving section 17a controls the opening of the aperture 17 by a motor (not shown).

The lens microcomputer 18 communicates with the camera body 11 via the electric contact of the mount 14 and carries out various controls in the lens unit 12. Moreover, the lens microcomputer 18 transmits a lens data and the like recorded on a ROM (not shown) to the camera body 11.

Incidentally, the lens unit 12 shown in FIG. 1 is just an example of the structure of a typical zoom lens unit. Thus, other than the above-described lens unit 12, for example, a lens unit without the lens microcomputer 18, a lens unit of a single focal lens, and the like can be attached to the camera body 11 of the first embodiment.

Next, the structure of the photographing mechanism of the camera body 11 is described. The camera body 11 includes a main mirror 21, a mechanical shutter 22, a first image sensor 23, a sub mirror 24, a focal point detecting section 25, a viewfinder optical system (32 to 35), a photometry section 26, a superimposing section (SI section) 27, an in-viewfinder monitor 28, an interchangeable lens 29, and a second image sensor 30.

The main mirror 21, the mechanical shutter 22, and the first image sensor 23 are disposed along the optical axis of the optical shooting system. The sub mirror 24 is disposed behind the main mirror 21. Moreover, the viewfinder optical system, the photometry section 26, the SI section 27, the in-viewfinder monitor 28, the lens 29, and the second image sensor 30 are disposed in an upper part of the camera body 11. Moreover, the focal point detecting section 25 is disposed in a lower region of the camera body 11. In addition, a hot shoe 31 for attaching a flash emission device or the like is provided in an upper part of the camera body 11.

The main mirror 21 is rotatably supported by means of a non-illustrated rotating shaft, and is switchable between an observation state and a retreated state. The main mirror 21 in the observation state is inclined and disposed in front of a mechanical shutter 22 and the first image sensor 23. The main mirror 21 in this observation state reflects a light flux passing through the optical shooting system upwards and leads the same to the viewfinder optical system. Moreover, a center part of the main mirror 21 is a half mirror. Then, a part of the light flux that is transmitted through the main mirror 21 is refracted downward by means of the sub mirror 24 and is led to the focal point detecting section 25. In addition, the focal point detecting section 25 detects an image shift amount of a subject image, the subject image being divided by a non-illustrated separator lens, for each AF area and carries out focus detection according to the so-called phase difference detecting method.

On the other hand, the main mirror 21 in the retreated state is positioned away from the photographing optical path by being flipped upward together with the sub mirror 24. When the main mirror 21 is in the retreated state, a light flux passing through the optical shooting system is led to the mechanical shutter 22 and the first image sensor 23.

The viewfinder optical system includes a diffusing screen (focal plane plate) 32, a condenser lens 33, a pentagonal prism 34, and an eyepiece lens 35. The pentagonal prism 34 among the optical elements of the viewfinder optical system is housed in a position of an overhang part 11a of the camera body 11.

The diffusing screen 32 is positioned above the main mirror 21, and a light flux reflected by the main mirror 21 in the observation state forms an image onto the diffusing screen 32 once. The light flux forming an image on the diffusing screen 32 passes through the condenser lens 33 and the pentagonal prism 34, and is led to an exit plane having an angle of 90° with respect to an incident plane of the pentagonal prism 34. Then, the light flux from the exit plane of the pentagonal prism 34 will reach a user's eye via the eyepiece lens 35. In addition, a plane opposite to the exit plane of the pentagonal prism 34 serves as a half mirror.

The photometry section 26 has a light-receiving plane in which photo detectors are disposed in two dimensions. Then, the photometry section 26 causes a part of the light flux forming an image on the diffusing screen 32 to re-form an image onto the light-receiving plane, whereby a photographing screen is divided into a plurality of portions according to a light flux passing through the optical shooting system, thus allowing photometry. In addition, the photometry section 26 is disposed in the vicinity of the pentagonal prism 34.

The SI section 27 carries out superimposing display (SI display), which superimposes the position of an AF area during photographing onto an optical image of the viewfinder optical system, by irradiating the diffusing screen 32 with an illumination light.

The in-viewfinder monitor 28 is disposed facing the half mirror plane (plane opposite to the exit plane) of the pentagonal prism 34. A view confirming image to be described below and the like are displayed on the in-viewfinder monitor 28.

The lens 29 is exposed to an exterior of the camera body 11 and is interchangeably attached to a lens fixing section 29a of the camera body 11. Moreover, the second image sensor 30 directly photographs a subject via the lens 29. The second image sensor 30 can photograph a subject from an optical path different from that in the first image sensor 23 that photographs with a light flux passing through the lens unit 12. In addition, the field angle of the lens 29 is set so as to be a wider angle than the field angle of the lens unit 12.

Moreover, the lens 29 and the second image sensor 30 of the first embodiment are housed in the overhang part 11a of the camera body 11. As shown in FIG. 2, the overhang part 11a of the camera body 11 is positioned substantially in a middle portion on the upper surface side of the camera body 11, and is formed in a shape projecting upward of the camera body 11. That is, because the positions of the lens 29 and second image sensor 30 are away from the position of the mount 13 of the camera body 11, it is less likely that the light flux from a subject is blocked by a lens-barrel of the lens unit 12 to produce shading.

Here, in the first embodiment, the following description is made assuming an through image of the first image sensor 23.

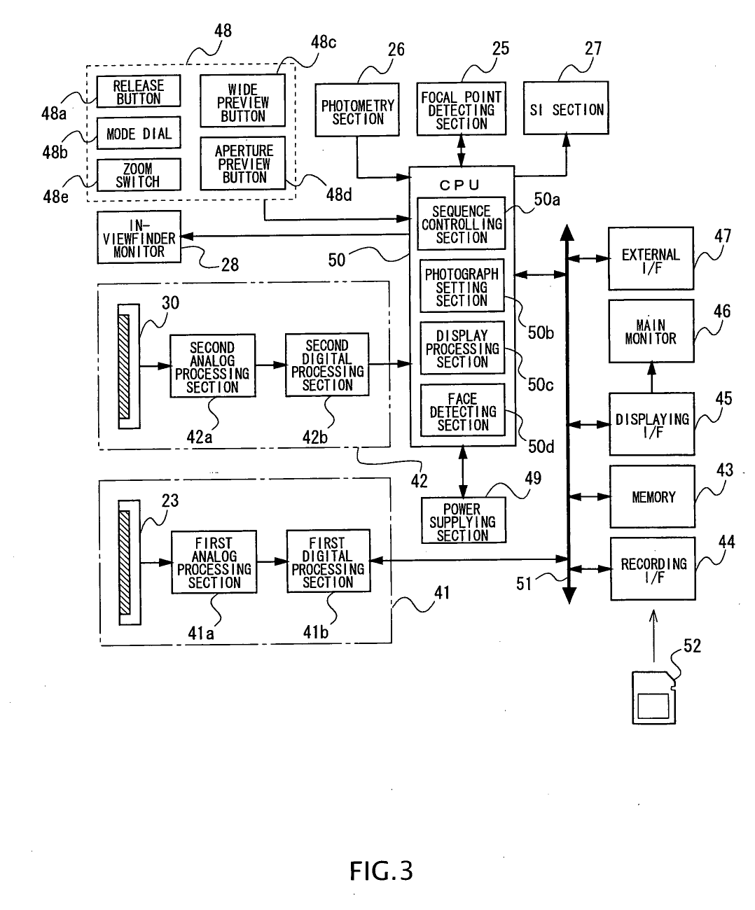

The first analog processing section 41a is an analog front end circuit that includes a CDS circuit, a gain circuit, an analog-to-digital conversion circuit, and the like. The CDS circuit reduces the noise component of an output of the first image sensor 23 by correlation double sampling. The gain circuit amplifies the gain of an input signal to output the input signal. This gain circuit can adjust the image pickup sensitivity that is equivalent to ISO sensitivity. The analog-to-digital conversion circuit analog-to-digital converts an output signal of the first image sensor 23. In addition, in FIG. 3, the illustration of the respective circuits of the first analog processing section 41a is omitted.

The first digital processing section 41b carries out various kinds of image processings (defective pixel correction, color interpolation processing, gray scale conversion processing, white balance adjustment, edge enhancement, and the like) to the output signal of the first analog processing section 41a to generate a data of the intended image. Moreover, the first digital processing section 41a carries out compression and expansion processing and the like of the data of the intended image. The first digital processing section 41a is connected to the system BUS 51.

The second image pickup section 42 includes the second image sensor 30, a second analog processing section 42a, and a second digital processing section 42b. In addition, because the configuration of the second image pickup section 42 substantially corresponds to the configuration of the first image pickup section 41, a part of the description regarding the duplicated portion between the both is omitted.

The second image sensor 30 photographs a view confirming image used for the viewfinder. The second image sensor 30 photoelectrically converts a subject image formed passing through the lens 29, at predetermined intervals and outputs a through image (view confirming image). An output signal of the second image sensor 30 is input to the second analog processing section 42a.

The second analog processing section 42a is an analog front end circuit that includes a CDS circuit, a gain circuit, an analog-to-digital conversion circuit, and the like. The second digital processing section 42b carries out color interpolation processing and the like of the through image. In addition, a data of the through image output from the second digital processing section 42b is input to the CPU 50.

The memory 43 is a buffer memory for temporarily recording the data of an intended image in a preceding step, a subsequent step, or the like of the image processing by the first digital processing section 41b.

A connector for connecting a recording medium 52 is formed in the recording I/F 44. Then, the recording I/F 44 carries out writing/reading of a photographic image data to/from the recording medium 52 connected to the connector. The above-described recording medium 52 is made of a hard disk, a memory card containing a semiconductor memory, and the like. In addition, FIG. 3 illustrates a memory card as an example of the recording medium 52.

The displaying I/F 45 controls the display of the main monitor 46 based on an instruction from the CPU 50. The main monitor 46 is disposed at the back part of the camera body 11 and the like, for example. The main monitor 46 displays various kinds of images in response to instructions from the CPU 50 and displaying I/F 45. For example, the main monitor 46 can display the reproduced image of an intended image, a menu screen capable of receiving GUI (Graphical User Interface) type inputs, and the like (illustration of each of the above-described images is omitted).

The external I/F 47 includes connection terminals compliant with a serial communications standard, such as USB (Universal Serial Bus). Then, the external I/F 47 controls data transmission and reception with a computer connected via the connection terminal, according to the above-described telecommunications standard.

The operation section 48 includes a plurality of switches for accepting the operations of a user. For example, the operation section 48 includes a release button 48a, a mode dial 48b, a wide preview button 48c, an aperture preview button 48d, and a zoom switch 48e.

The release button 48a accepts an instruction input for starting an AF operation before photographing and an instruction input for starting an exposure operation during photographing, from a user. The mode dial 48b accepts an input for switching the photographing modes, from a user. The wide preview button 48c accepts from a user an operation for switching between the viewfinder display of an optical image by means of the viewfinder optical system and the display of a view confirming image (wide preview display) by means of the in-viewfinder monitor 28. The aperture preview button 48d accepts from a user a confirming input for confirming the range of depth of field. If there is this confirming input, the aperture 17 is squeezed down and a user can confirm the range of depth of field by means of the viewfinder optical system. The zoom switch 48e accepts from a user an operation for optically or electronically increasing/decreasing the magnifying power of the view confirming image.

The power supplying section 49 supplies the electric power of a non-illustrated battery to each part of the camera body 11. Moreover, the power supplying section 49 detects the remaining amount of battery based on the battery voltage.

The CPU 50 carries out an overall control of each part of the electronic camera. Moreover, the CPU 50 functions as a sequence control section 50a, a photograph setting section 50b, a display processing section 50c, and a face detecting section 50d, by means of programs stored in a non-illustrated ROM.

The sequence control section 50a carries out operation control and the like of the lens unit 12, the main mirror 21, the mechanical shutter 22, the first image pickup section 41, the second image pickup section 42, and the like. Moreover, the sequence control section 50a carries out control for switching between the finder display by means of the viewfinder optical system and the wide preview display, in response to the operation of the wide preview button 48c. In addition, the sequence control section 50a functions also as an emission control section that carries out emission control of an external flash emission device (not shown).

The photograph setting section 50b carries out an automatic exposure (AE) calculation, an auto white balance (AWB) calculation, and the like, while carrying out auto-focus (AF), and determines various kinds of parameters (exposure time, aperture value, image pickup sensitivity, and the like) of the photographing condition of the first image pickup section 41. Moreover, the photograph setting section 50b is also responsible for processings regarding AF, AE, and AWB of the second image pickup section 42.

More specifically, the photograph setting section 50b calculates a defocusing amount (deviation amount from a focus position and the direction thereof) of the focus lens 16 for each AF area based on an image phase difference amount in the focal point detecting section 25. Moreover, the photograph setting section 50b carries out the AE calculation and AWB calculation based on an output of the photometry section 26. In addition, the photograph setting section 50b can also carry out each calculation of the AF, AE, and AWB based on the data of a through image of the first image sensor 23 or the second image sensor 30.

The display processing section 50c performs various kinds of image processings on the data of the through image of the second image pickup section 42. In addition, a view confirming image output from the display processing section 50c is displayed on the in-viewfinder monitor 28.

The face detecting section 50d performs the well-known face detection processing on the data of the through image of the second image pickup section 42, and detects the face area of a subject contained in the view confirming image. For example, the face detecting section 50d extracts the face area by an extraction processing of the characteristic points of a face described in Japanese Unexamined Patent Application Publication No. 2001-16573 and the like. The above-described characteristic points include each end point of the eyebrow, eye, nose, and lip, a contour point of the face, a vertex of the head, a lower end point of the jaw, and the like, for example. Or, as in Japanese Unexamined Patent Application Publication No. 8-63597, the face detecting section 50d may extract the contour of a skin-colored region based on color information on a subject, and detect the face by further performing the matching with the template of a face component that is prepared in advance.

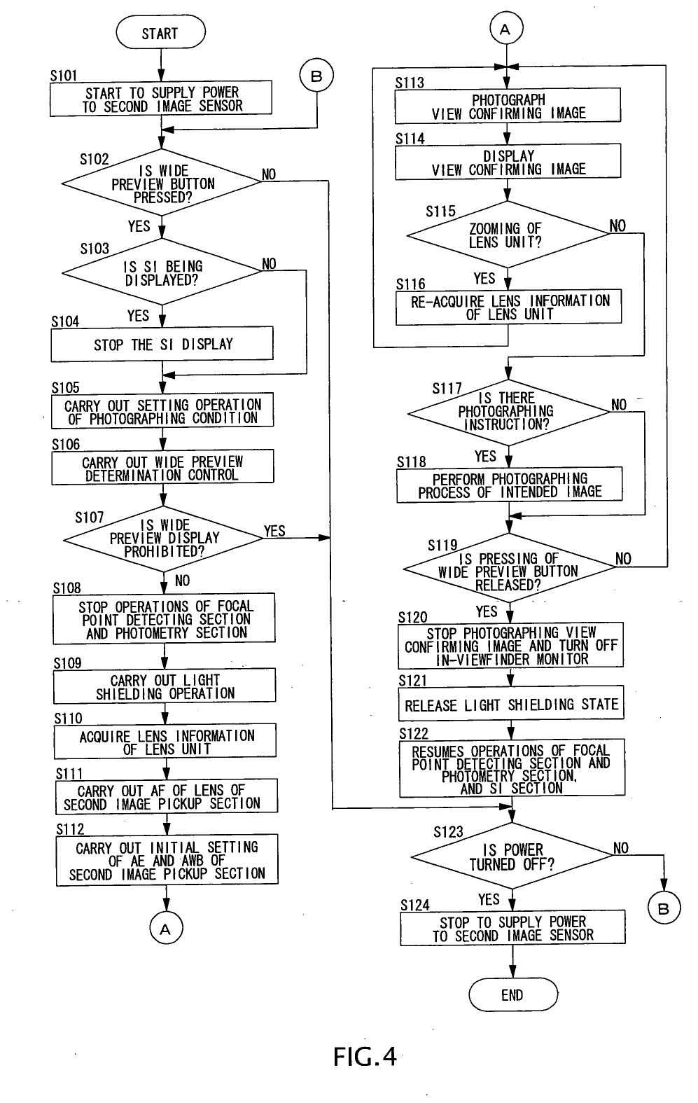

Hereinafter, the operation of the electronic camera regarding the wide preview display in the first embodiment is described with reference to a flow chart of FIG. 4.

Step 101: when a user turns on the power of the camera body 11, the CPU 50 will start to supply power to the second image sensor 30. In the stage of S101, the main mirror 21 is in the observation position. Thus, a user can observe from the eyepiece lens 35 a subject image formed by a light flux that passed through the lens unit 12. In addition, in FIG. 5, a display state of an optical image of a subject in the viewfinder optical system is shown.

Step 102: the CPU 50 determines whether or not the wide preview button 48c is being pressed. If the wide preview button 48c is being pressed (YES side), the flow shifts to S103. On the other hand, if the wide preview button 48c is not being pressed (NO side), the flow shifts to S123.

Step 103: the CPU 50 determines whether or not the SI section 27 is carrying out SI display of an AF area while the wide preview button 48c is pressed. If the SI display is being carried out (YES side), the flow shifts to S104. On the other hand, if the SI display is not being carried out (NO side), the flow shifts to S105.

Step 104: the CPU 50 instructs the SI section 27 to stop the SI display. This is because an optical image by the viewfinder optical system is not displayed in the wide preview display and thus the SI display is not required.

Step 105: the CPU 50 performs a setting-operation of the photographing condition. Specifically, the CPU 50 carries out AF based on an output of the focal point detecting section 25. Moreover, the CPU 50 carries out the AE calculation and AWB calculation based on an output of the photometry section 26. In addition, in S105, the SI display of an AF area by the SI section 27 is not carried out.

Step 106: the CPU 50 carries out wide preview determination control to determine whether or not it is the case where the wide preview display is prohibited.

Specifically, if the case corresponds to either one of the following conditions: (1) when light emission by the flash-emission device is carried out during photographing and (2) when the brightness of field is not more than a threshold, then the CPU 50 turns on a flag for prohibiting the wide preview display.

Step 107: the CPU 50 determines whether or not the flag for prohibiting the wide preview display has been turned on in the wide preview determining control (S106). If the wide preview display is prohibited (YES side), the flow shifts to S123. On the other hand, if the wide preview display is allowed (NO side), the flow shifts to S108.

Step 108: the CPU 50 stops the operations of the focal point detecting section 25 and photometry section 26 prior to starting the wide preview display. This is because the focal point detecting section 25 and the photometry section 26 will be unable to function by the below-described light shielding operation during the wide preview display.

Step 109: the CPU 50 performs the light shielding operation to cut off the incident light from the lens unit 12 onto the viewfinder optical system.

Specifically, the CPU 50 moves the main mirror 21 from the observation position to the retreated position to cut off the incident light onto the viewfinder optical system. In addition, if the brightness of field is sufficiently low, the CPU 50 may cut off the incident light onto the viewfinder optical system by squeezing down the aperture 17.

Step 110: the CPU 50 acquires lens information (lens positions and the like of the zoom lens 15 and focus lens 16) from the lens unit 12.

Step 111: the CPU 50 carries out AF of the lens 29 based on the lens position of the focus lens 16 among the lens information in S110. In addition, if the lens 29 is of a pan-focus type and does not have the AF function, the step of S111 is omitted.

Step 112: the CPU 50 initializes the AE and AWB of the second image pickup section 42 based on the photographing condition acquired in S105. In addition, after the start of photographing in the second image pickup section 42, the CPU 50 adjusts the parameters of the AE and AWB of the second image pickup section 42 based on the data of a through image of the second image pickup section 42.

Step 113: the CPU 50 photographs a view confirming image with the second image sensor 30 of the second image pickup section 42. Then, the second image pickup section 42 outputs data of the view confirming image to the CPU 50.

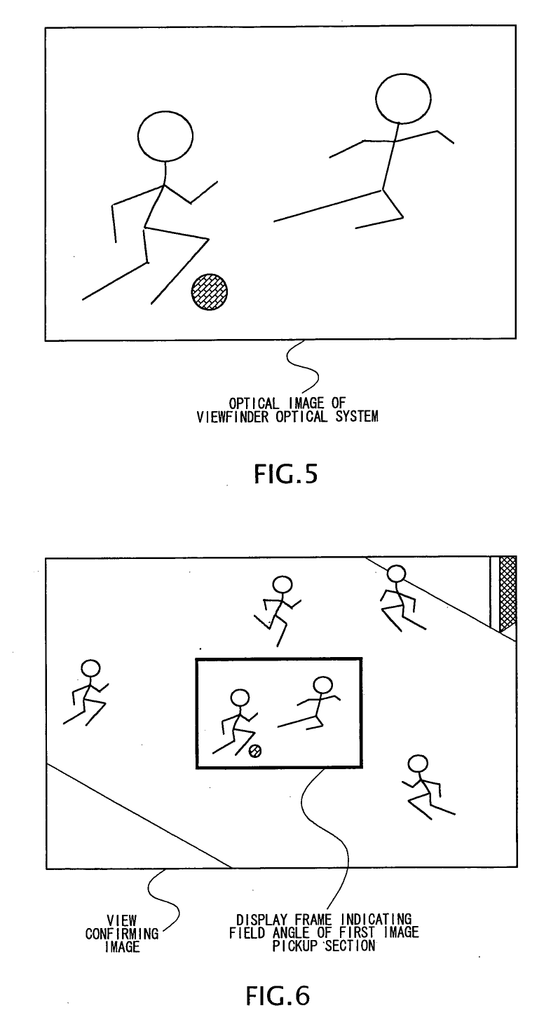

Step 114: the display processing section 50c of the CPU 50 displays the view confirming image on the in-viewfinder monitor 28 (S113). Since the field angle of the lens 29 has a wider angle than the field angle of the lens unit 12 has, the view confirming image can display a subject in a wider range than an optical image of the viewfinder optical system can. Moreover, FIG. 6 shows an example of display of the view confirming image corresponding to the scene of FIG. 5.

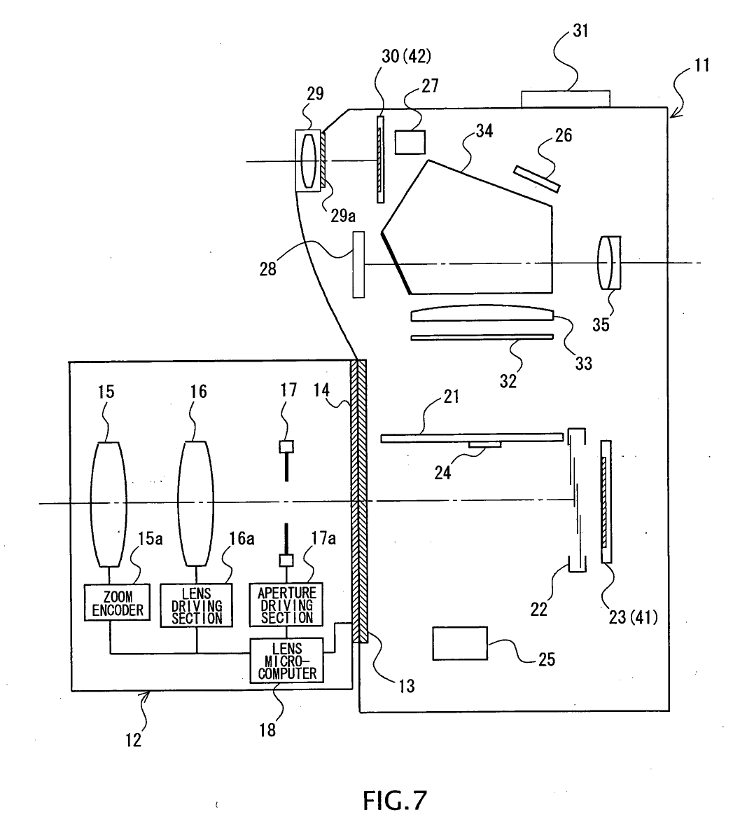

Here, FIG. 7 shows a state of the camera body 11 during the wide preview display. Since the incident light from the lens unit 12 onto the viewfinder optical system is cut off by the light shielding operation (S109) during the wide preview display, a user can observe only the view confirming image (S113) of the in-viewfinder monitor 28 from the eyepiece lens 35. Thus, a user can observe the field with a view confirming image, which is wider-angled than the image of the viewfinder optical system, without detaching eyes from the eyepiece lens 35. In addition, FIG. 7 shows an example of the light shielding state in which the main mirror 21 is moved to the retreated position during the light shielding operation.

Moreover, the display processing section 50c performs display processing that indicates the range of a field angle of the first image pickup section 41 on the view confirming image. For example, the display processing section 50c calculates the range of a field angle of the first image pickup section 41 in a view confirming image based on the lens information (S110) and a data of the zoom position of the lens 29. Then, the display processing section 50c overlappingly displays a frame, which indicates a range of the above-described field angle on a view confirming image of the in-viewfinder monitor 28, by an on-screen function (see FIG. 6). In this case, a user can also know the photographing area of the first image pickup section 41 from the view confirming image.

In addition, the CPU 50 in S114 can carry out the zooming of the lens 29 or the electronic zooming of a view confirming image by the display processing section 50c, in response to a user's operation of the zoom switch 48e.

Step 115: the CPU 50 determines whether or not there is a change in the lens position of the zoom lens 15 of the lens unit 12 (whether the lens unit 12 has been zoomed). If there is a change in the lens position due to the zooming of the lens unit 12 (YES side), the flow shifts to S116. On the other hand, if there is no change in the lens position (NO side), the flow shifts to S117.

Step 116: the CPU 50 re-acquires the lens information regarding the lens position of the zoom lens 15, from the lens unit 12. Then, returning to S113, the CPU 50 repeats the above-described operations. In this way, in the display processing in S114, the display processing section 50c can display a frame that reflects a change in the field angle due to the zooming of the zoom lens 15.

Step 117: the CPU 50 determines whether or not there is a photographing instruction by the press of the release button 48a. If there is a photographing instruction (YES side), the flow shifts to S118. On the other hand, if there is no photographing instruction (NO side), the flow shifts to S119.

Step 118: the CPU 50 performs photographing process of an intended image, and photographs the intended image with the first image sensor 23 of the first image pickup section 41. Subsequently, the first image pickup section 41 generates an image data of the intended image, and the CPU 50 records the image data of the intended image onto the recording medium 52.

Here, in the photographing process of the intended image of S118, the CPU 50 operates the focal point detecting section 25 and the photometry section 26 to re-set the photographing condition before photographing while once releasing the wide preview display and the light shielding state caused by light shielding operation. Then, the CPU 50 photographs the intended image based on the photographing condition that is re-set immediately before photographing. In this case, the CPU 50 resumes the wide preview display after completion of the photographing.

In addition, the CPU 50 may photograph the intended image based on the photographing condition of S105 without releasing the state of the light shielding operation. In this case, the subject can be photographed more quickly because the operation of re-setting the photographing condition can be omitted.

Step 119: the CPU 50 determines whether or not the pressing of the wide preview button 48c has been released. If the pressing of the wide preview button 48c has been released (YES side), the flow shifts to S120. On the other hand, if the wide preview button 48c is being pressed (NO side), the CPU 50 returns to S113 and continues the wide preview display. That is, while the wide preview button 48c is pressed, the CPU 50 keeps displaying, in a motion image mode, the view confirming image in the in-viewfinder monitor 28.

Step 120: the CPU 50 stops photographing the view confirming image in the second image pickup section 42 and turns off the in-viewfinder monitor 28.

Step 121: the CPU 50 releases the light shielding state caused by the light shielding operation. Thus, a user can observe again a subject image formed by the light flux that passed through the lens unit 12, from the eyepiece lens 35.

Step 122: the CPU 50 resumes the operations of the focal point detecting section 25 and photometry section 26. Moreover, the CPU 50 instructs the SI section 27 to resume the SI display.

Step 123: the CPU 50 determines whether or not there is an operation to turn off the power of the camera body 11. If there is the above-described operation (YES side), the flow shifts to S124. On the other hand, if there is no such operation (NO side), the CPU 50 returns to S102 and repeats the above-described operations.

Step 124: the CPU 50 stops to supply power to the second image sensor 30. Now, the description of the operations according to the flow chart of FIG. 4 is completed.

Hereinafter, an effect of the first embodiment is described. The electronic camera of the first embodiment photographs a view confirming image from an optical path different from that of the first photographing part 41 by means of the second photographing part 42 and at the same time displays the view confirming image observably from the eyepiece lens 35 by means of the in-viewfinder monitor 28. Thus, depending on state, a user can selectively observe an optical image by means of the viewfinder optical system and a view confirming image by means of the second image pickup section 42 without detaching eyes from the eyepiece lens 35.

Especially when a telephoto lens with a narrow field angle is mounted on the camera body 11, the field of view of an optical image by means of the viewfinder optical system becomes narrow, however, even in this case a user can appropriately know the state of field by the wide-angle view confirming image. Accordingly, even in the case where a moving subject is telescopically photographed, e.g., in photographing sports and the like, a user can track the subject relatively easily, so that the user is less likely to miss a photo opportunity.

Moreover, in the first embodiment, the lens 29 is mounted via the lens fixing section 29a and is interchangeable with respect to the camera body 11. Thus, a user can display a view confirming image satisfying the user's need by selecting the appropriate lens 29 in consideration of the focal length of the lens unit 12, a scene to be photographed, and the like.

Moreover, in the first embodiment, a user can adjust the range of field, which can be confirmed with the view confirming image, by zooming of the lens 29 and electronic zooming of the view confirming image. It is therefore possible to provide a user with a view confirming image appropriate to a scene to be photographed. Especially when the lens 29 is a zoom lens and the view confirming image is optically zoomed, it is possible to provide a user with a clear image as compared with the one in the case of electronic zoom.

### Description of Second Embodiment

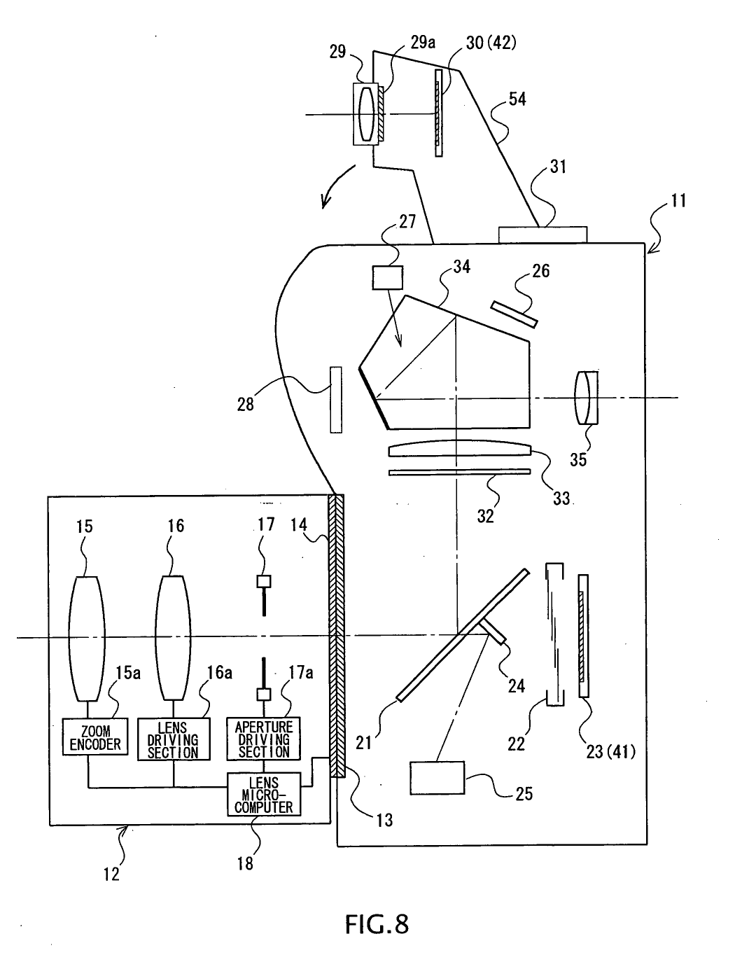

FIG. 8 is a view illustrating the photographing mechanism of an electronic camera in a second embodiment. Here, in the following description of the embodiments, constituent elements of the camera are in common with those of the first embodiment and are given the same reference numerals to omit the duplicated description.

The second embodiment is a variation of the first embodiment, showing an example in which the second image pickup section 42 is attached to a movable member 54 that houses an emitting section 53 used for flash photographing. A base side of the movable member 54 is rotatably supported to the camera body 11 with a rotating shaft (not shown). Then, the movable member 54 can rotate with respect to the camera body 11 to thereby switch between a first position and a second position.

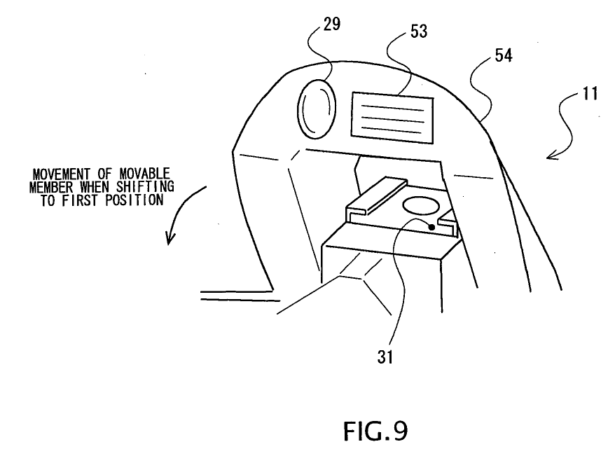

When the movable member 54 is in the first position, the movable member 54 is housed in the camera body 11 and the movable member 54 configures a part of the surface of the camera body 11. On the other hand, when the movable member 54 is in the second position, a tip side of the movable member 54, to which the second image pickup section 42 and the emitting section 53 are attached, projects from the camera body 11 (see FIG. 9). Thus, when the movable member 54 is in the second position, the irradiation of a subject with emission of the emitting section 53 and the photographing of a view confirming image by means of the second image pickup section 42 are enabled. Here, the emitting section 53 and the lens 29 of the second image pickup section 42 are disposed side by side on the tip side of the movable member 54.

In the second embodiment described above, in addition to substantially the same effect as that of the first embodiment, the photographing position of the second image pickup section 42 can be far away from the optical axis of the lens unit 12. It is therefore possible to reduce the possibility of shading of a view confirming image by a lens-barrel of the lens unit 12, as compared with the case of the first embodiment. Moreover, in the second embodiment, because the second image pickup section 42 can be housed in the camera body 11 when not in use by moving the movable member 54, sense of design and functionality of the camera body 11 can be enhanced.

### Description of Third Embodiment

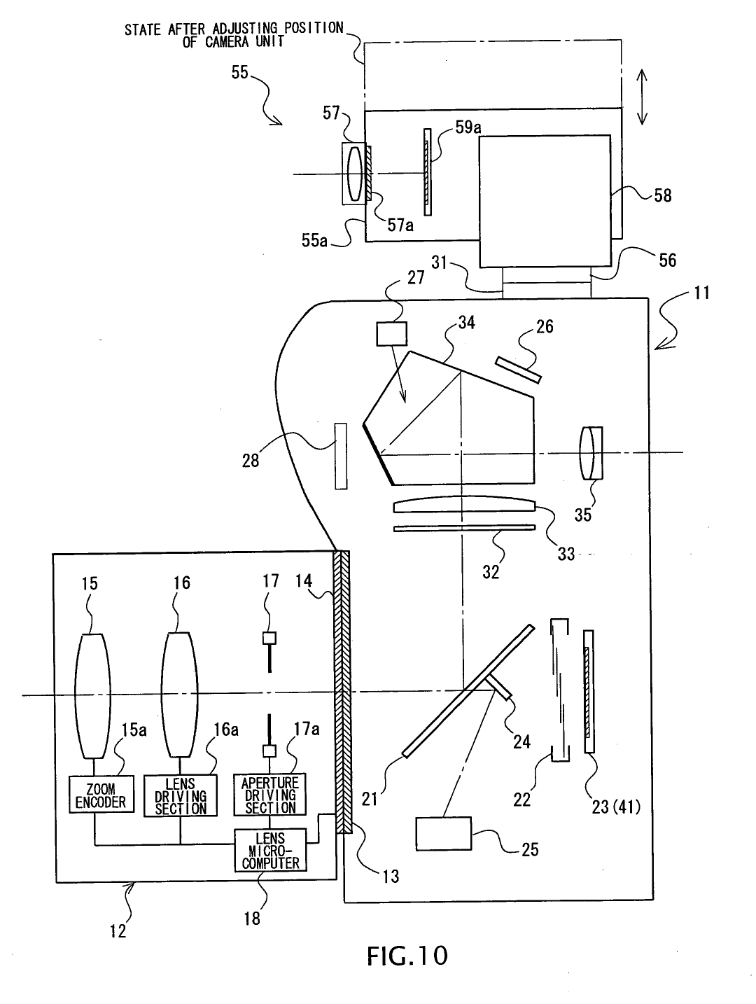

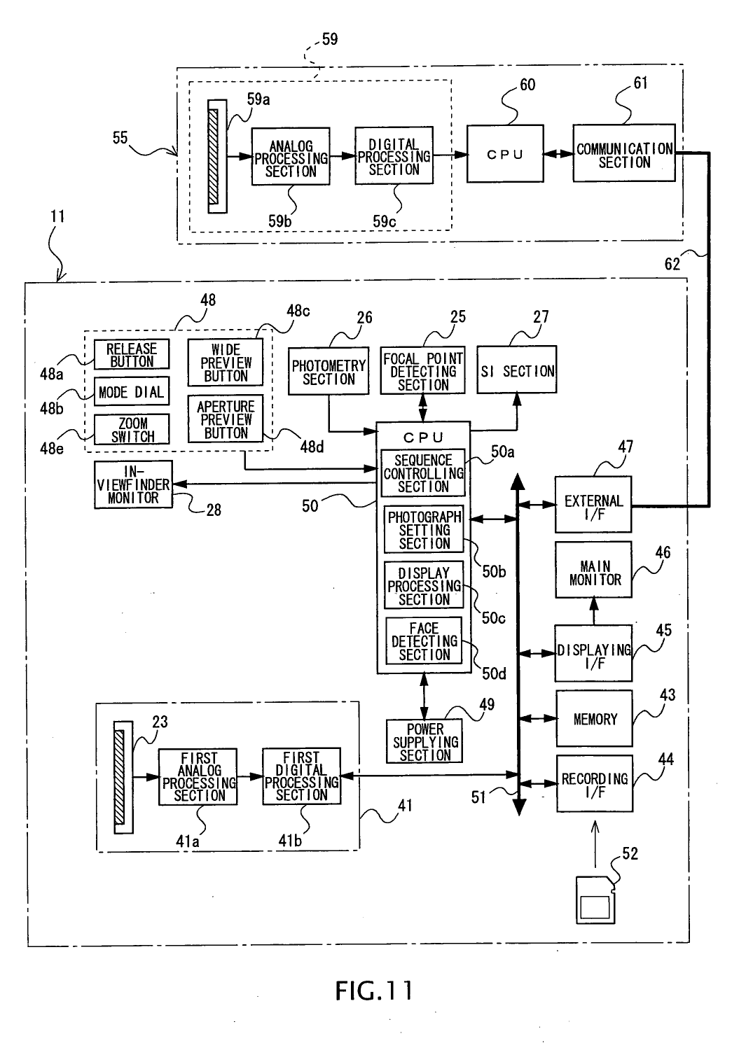

FIG. 10 is a view illustrating the photographing mechanism of an electronic camera in a third embodiment. Moreover, FIG. 11 is a block diagram of an electronic camera system in the third embodiment. The third embodiment shows an example in which the camera system is configured by externally attaching a camera unit 55, which photographs a view confirming image, to the camera body 11.

The camera system of the third embodiment includes the camera body 11 and the camera unit 55. The camera body 11 in the third embodiment has a configuration substantially common with that of the camera body 11 of the first embodiment, except for not including the lens fixing section 29a and the second image pickup section 42. The camera body 11 carries out communication with the camera unit 55 via the external I/F 47. In addition, in the third embodiment, the camera unit 55 is mounted in the hot shoe 31 of the camera body 11.

On the other hand, as shown in FIG. 10, the camera unit 55 includes a fixing section 56 for engaging with the hot shoe 31, a lens 57 and a lens fixing section 57a, and a position adjusting section 58. The lens 57 and the lens fixing section 57a are mounted on a body part 55a of the camera unit 55. Moreover, the lens 57 is detachable to the lens fixing section 57a, and various kinds of interchangeable lenses can be attached to the lens fixing section 57a. In addition, the configuration of the above-described lens 57 and lens fixing section 57a is substantially in common with the configuration of the lens 29 and lens fixing section 29a of the first embodiment.

The position adjusting section 58 is a pedestal-shaped member having the fixing section 56 on its bottom face section, and supports the body part 55a of the camera unit 55 slidably in the height direction (vertical direction in the view) of the camera system. The position adjusting section 58 serves in such a manner that a user may adjust a distance from the optical axis of the lens 57 of the camera unit 55 to the fixing section 56. Thus, even if the camera unit 55 is attached to the camera body 11 of a different model, the parallax of the camera unit 55 can be adjusted by adjusting the distance between the optical axis of the optical shooting system and the optical axis of the lens 57 by means of the position adjusting section 58, so that the compatibility of the camera unit 55 can be increased. Moreover, due to the adjustment of the position of the optical axis of the lens 57 by a user by means of the position adjusting section 58, it is also possible to prevent the shading of a view confirming image caused by the lens-barrel of the lens unit 12.

Moreover, as shown in FIG. 11, the camera unit 55 includes an image pickup section 59, a CPU 60, and a communication section 61. The image pickup section 59 includes an image sensor 59a, an analog processing section 59b, and a digital processing section 59c. The image sensor 59a photoelectrically converts a subject image formed passing through the lens 57, at predetermined intervals and outputs a through image (view confirming image). The output signal of the image sensor 59a is input to the analog processing section 59b. The analog processing section 59b is an analog front end circuit that includes a CDS circuit, a gain circuit, an analog-to-digital conversion circuit, and the like. The digital processing section 59c performs color interpolation processing and the like of the through image.

The CPU 60 controls each part of the camera unit 55 based on instructions from the camera body 11.

The communication section 61 is connected to the external I/F 47 via a cable 62. The communication section 61 transmits data of a view confirming image to the camera body 11 while receiving an instruction from the camera body 11.

The operation of a wide preview display by the camera system of the third embodiment is substantially in common with that in the case of the first embodiment except that the camera unit 55 carries out the operation of the second image pickup section 42, so the detailed description is omitted.

Also with the camera system of the third embodiment described above, substantially the same effect as that of the first embodiment can be obtained.

### Supplementary Notes on Embodiments

In the above-described embodiments, an example regarding a single lens reflex electronic camera has been mainly described, however, the present invention can be also applied to a film-based camera that photographs an intended image by exposing a subject image onto a film. Moreover, in the above-described embodiments, the lenses 29, 57 for photographing a view confirming image may be non-interchangeable with respect to the camera body 11 or the camera unit 55.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A camera comprising:
a first image pickup section photographing a recording-purpose image;
a viewfinder optical system including an eyepiece section capable of observing an optical image of a subject with a light flux from a photographing optical path of said first image pickup section;
a second image pickup section photographing a view confirming image from an optical path different from that of said first image pickup section; and
a displaying section providing said view confirming image to said eyepiece section.

2. The camera according to claim 1, wherein
said second image pickup section is disposed in an overhang part housing an optical element of said viewfinder optical system, the overhang part formed in an upper part of a camera body.

3. The camera according to claim 1, further comprising:
a movable member configured to be movable between a first position where the movable member is housed in a camera body and a second position where the movable member projects from said camera body, wherein
said second image pickup section is attached to said movable member.

4. The camera according to claim 3, wherein
an emitting section irradiating said subject is contained in said movable member.

5. The camera according to claim 1, wherein
said second image pickup section includes a lens interchanging section to which lenses having respectively different focal lengths can be interchangeably detached and attached.

6. The camera according to claim 1, wherein
said second image pickup section includes a zoom lens capable of changing a focal length.

7. The camera according to claim 1, further comprising:
an operation section accepting from a user a displaying operation asking for display of said view confirming image; and
a controlling section causing said displaying section to display said view confirming image based on said displaying operation.

8. A camera unit externally attached to a camera body and photographing a view confirming image from an optical path different from a photographing optical path of said camera body, said camera unit comprising:
an image pickup section photographing said view confirming image;
a communication section outputting said view confirming image to said camera body;
a fixing section connecting with said camera body; and
a position adjusting section adjusting parallax with an image pickup section of said camera body.

9. The camera unit according to claim 8, wherein
said image pickup section includes a lens interchanging section to which lenses having respectively different focal lengths can be interchangeably detached and attached.

10. The camera unit according to claim 8, wherein
said image pickup section includes a zoom lens capable of changing a focal length.

11. A camera capable of attaching an external camera unit, comprising:
a fixing section connecting said camera unit;
an image pickup section photographing a recording-purpose image;
a viewfinder optical system including an eyepiece section capable of observing an optical image of a subject with a light flux from a photographing optical path of said first image pickup section;
a communication section receiving from said camera unit a view confirming image photographed through an optical path different from that of said image pickup section; and
a displaying section providing said view confirming image to said eyepiece section.

12. The camera according to claim 11, further comprising:
an operation section accepting from a user a displaying operation asking for display of said view confirming image; and
a controlling section causing said displaying section to display said view confirming image based on said displaying operation.

13. A camera system having a camera body and a camera unit externally attached to said camera body wherein:
said camera unit comprising:
a second image pickup section photographing a view confirming image from an optical path different from a photographing optical path of said camera body;
a second communication section outputting said view confirming image to said camera body; and
a second fixing section connecting with said camera body; and wherein:
said camera body comprising:
a first fixing section connecting said camera unit;
a first image pickup section photographing a recording-purpose image;
a viewfinder optical system having an eyepiece section capable of observing an optical image of a subject with a light flux from a photographing optical path of said first image pickup section;
a first communication section receiving said view confirming image from said camera unit; and
a displaying section providing said view confirming image to said eyepiece section.
